(19) United States
(12) Patent Application Publication
(10) Pub. No.: US 2006/0181412 A1
(43) Pub. Date: Aug. 17, 2006

(54) Multi-sensor system for identification and data collection

(76) Inventors: Giovanni Gualdi, Modena (IT); Cyril Brignone, Palo Alto, CA (US); Salil Pradhan, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/048,291

(22) Filed: Jan. 31, 2005

(51) Int. Cl. G08B 1/08; G05B 19/00; G08B 13/14

(52) U.S. Cl. 340/539.22; 340/572.1; 340/539.26; 340/5.61

(57) ABSTRACT

Embodiments of the present invention recite a multi-sensor system for identification and data collection. In one embodiment, the present invention comprises an identification system for determining the identity of a target object. The present invention further comprises a physical sensing system for determining a sensible characteristic of the target object. Finally, the present invention comprises a monitoring system which is coupled with the identification system and with the physical sensing system. The monitoring system is for comparing a virtually described characteristic which is associated with the identity of the target object with the sensible characteristic of the target object.

### TECHNICAL FIELD

Embodiments of the present invention relate to the field of systems for identifying and tracking of objects.

### BACKGROUND ART

Many commercial entities use automated identification systems such as barcode readers or radio frequency identification (RFID) tags to identify items which are being shipped. For example, a shipping pallet typically has an affixed barcode plate which uniquely identifies that particular pallet. When the barcode plate is read, the pallet is identified and a database is accessed which describes the contents of that pallet. RFID systems utilize portable tags comprising a transceiver and a memory chip which stores a unique identification number. An RFID reader comprising an antenna and transceiver emits a signal which activates the RFID tag when the tag is proximate to the reader. The tag then generates a signal which conveys the unique identification number to the reader.

While these systems are widely utilized due to their ability to quickly catalog large numbers of items, identifying the object is of limited value unless it is associated with meaningful data. For example, the database description of the contents of a pallet may not reflect what is actually on the pallet. There are a variety of reasons why the database description does not correspond with the actual contents of the pallet. For example, products may be inadvertently left off the pallet when it is shipped. Products may also fall off or be knocked off of the pallet, or be stolen, while the pallet is being transported. Alternatively, a clerical error may result in an incorrect description of the items which are associated with a particular pallet. For example, the clerical operator may have intended to enter that a given pallet comprises 29 items and instead enters that it contains 28 or 92 items.

This problem is compounded by the fact that, typically, no action is taken to identify the contents of the pallet other than reading the barcode or RFID tag. In other words, the database description is not typically correlated with the actual contents of the pallet until some time after the pallet arrives at its final destination. As a result, each entity in the supply chain incorrectly assumes that the database description of the pallet's contents is correct and is accordingly billed for an amount of products which may or may not be correct. This problem is pervasive enough that many large retailers only pay a percentage of what they are billed for a particular pallet of products because past experience has indicated a certain level of error in the billing process. For example, a large chain of stores might receive a pallet of 100 items and pay the manufacturer for 90 items because past experience has shown that, on average, each pallet received from that manufacturer only contains 90% of the items listed in the invoice.

### DISCLOSURE OF THE INVENTION

Embodiments of the present invention recite a multi-sensor system for identification and data collection. In one embodiment, the present invention comprises an identification system for determining the identity of a target object. The present invention further comprises a physical sensing system for determining a sensible characteristic of the target object. Finally, the present invention comprises a monitoring system which is coupled with the identification system and with the physical sensing system. The monitoring system is for comparing a virtually described characteristic which is associated with the identity of the target object with the sensible characteristic of the target object.

### BRIEF DESCRIPTION OF THE DRAWINGS

The accompanying drawings, which are incorporated in and form a part of this specification, illustrate embodiments of the present invention and, together with the description, serve to explain the principles of the invention. Unless specifically noted, the drawings referred to in this description should be understood as not being drawn to scale.

FIG. 1 is a block diagram of an exemplary multi-sensor system in accordance with embodiments of the present invention.

FIG. 2 is a diagram of a multi-sensor environment in accordance with embodiments of the present invention.

FIG. 3 is a block diagram of an exemplary monitoring system in accordance with embodiments of the present invention.

FIG. 4 is a block diagram of another exemplary multi-sensor system in accordance with embodiments of the present invention.

FIG. 5 is a flowchart of a method for identification of a target object in accordance with embodiments of the present invention.

FIG. 6 is a block diagram of an exemplary computer system upon which embodiments of the present invention may be implemented.

### MODES FOR CARRYING OUT THE INVENTION

Reference will now be made in detail to embodiments of the present invention, examples of which are illustrated in the accompanying drawings. While the present invention will be described in conjunction with the following embodiments, it will be understood that they are not intended to limit the present invention to these embodiments alone. On the contrary, the present invention is intended to cover alternatives, modifications, and equivalents which may be included within the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

Notation and Nomenclature

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signal capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining,” “comparing,” “utilizing,” “storing,” “detecting,” “initiating,” “routing,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

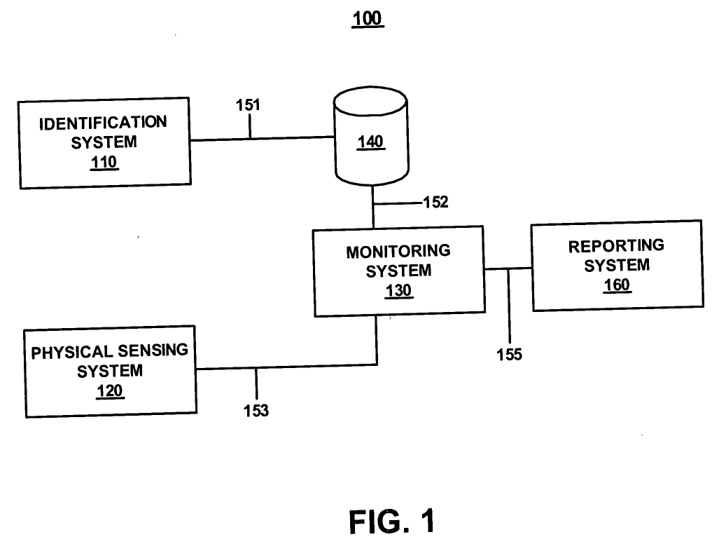

FIG. 1 is a block diagram of an exemplary multi-sensor system 100 in accordance with embodiments of the present invention. Embodiments of the present invention comprise an identification system (e.g., 110 of FIG. 1), a physical sensing system (e.g., 120 of FIG. 1), a data storage system (e.g., 140 of FIG. 1) which are communicatively coupleable with a monitoring system (e.g., 130 of FIG. 1). In FIG. 1, identification system 110 exchanges data with data storage system 140 via coupling 151 and data storage system 140 exchanges data with monitoring system 130 via coupling 152. Similarly, physical sensing system 120 exchanges data with monitoring system 130 via coupling 153. Identification system 110, physical sensing system 130, data storage system 140 and monitoring system 130 are utilized in embodiments of the present invention to identify a target object 150, determine a sensible characteristic of target object 150, and compare a virtually described characteristic of target object 150 (e.g., stored in data storage system 140) with the sensible characteristic.

In embodiments of the present invention, in response to comparing the virtually described characteristic of target object 150 with the sensible characteristic of target object 150, monitoring system 130 initiates an action. For example, embodiments of the present invention may also comprise a reporting system 160 for generating a report or message. In another embodiment, monitoring system 130 may be coupled with a routing device to send target object 130 to a particular destination in response to comparing a virtually described characteristic of target object 150 with a sensible characteristic.

It is appreciated that embodiments of the present invention are well suited to utilize configurations other than those shown in FIG. 1. For example, in other embodiments of the present invention, data storage system 140 may be coupled with identification system 110 and with monitoring system 130 via a separate coupling (not shown). Additionally, in embodiments of the present invention, data storage system 140 may be implemented as a component of identification system 110, physical sensing system 120, and/or monitoring system 130. Additionally, data storage system 140 may be implemented as a distributed system in accordance with embodiments of the present invention. In embodiments of the present invention, couplings 151, 152, 153, and 155 may be wireless communication couplings.

As described above, identification system 110 is for identifying a target object (e.g., 150). In the following discussion, the target object will be understood to mean a pallet or other type of shipping container which may also comprise a plurality of sub-components (e.g., individual boxes). However, in another embodiment, the target object may be an individual item such as an individual box or container.

In embodiments of the present invention, identification system 110 comprises an automatic identification system. Examples of automatic identification systems which may be implemented by identifications system 110 in accordance with embodiments of the present invention include, but are not limited to, barcode reading systems, image recognition systems, and implementations of radio frequency identification (RFID) systems. While the present invention recites automatic identification systems specifically, embodiments of the present invention may utilize a human operator using a data input/output terminal to identify a target object. In embodiments of the present invention, identification system 110 may determine the identity of target object 150, or individually identify a plurality of sub-components of target object 150. For example, a plurality of boxes on a pallet may be individually identified with a unique barcode, RFID device, or other identification.

In embodiments of the present invention, physical sensing system 120 is for determining at least one sensible characteristic of a target object. For the purposes of the present invention, the term “sensible characteristic” means a measurable parameter of an object such as size, shape, weight, volume, temperature, color, odor, electro-magnetic emissions, etc. Additionally embodiments of the present invention may utilize more than one of these parameters to determine the sensible characteristic of the target object. For example, measurements of the volume and the weight of a target object may be aggregated to determine the density of the target object. In embodiments of the present invention, physical sensing system 120 comprises one or more sensors for determining the sensible characteristic of the target object.

In embodiments of the present invention, data storage system 140 comprises a database for associating target object 150 with a virtually described characteristic. For example, a relational database may be implemented which matches the identity of target object 150 with a table comprising the virtually described characteristics of target object 150. Examples of a virtually described characteristic in accordance with embodiments of the present invention may include, but are not limited to: size, shape, weight, temperature, color, volume, odor, or electro-magnetic emissions from target object 150. The virtually described characteristic comprises a description of an anticipated characteristic of target object 150 which may or may not necessarily be an accurate description of the target object. For example, a pallet comprising 100 boxes, each weighing 1 pound should have an anticipated weight of 100 pounds plus the weight of the pallet.

In embodiments of the present invention, a virtually described characteristic may describe a characteristic of a sub-component (e.g., an individual box) of target object 150. For example, any of the above virtually described characteristics may describe one box of a plurality of substantially identical boxes on a pallet. Alternatively, a virtually described characteristic of each of a plurality of unique sub-components of target object 150 may be individually stored in data storage system 140.

Embodiments of the present invention are advantageous over conventional identification systems which fail to determine whether the virtually described characteristics of an object correspond with the actual characteristics of the object. As described above, there are a variety of reasons for a discrepancy between the virtual description and the actual characteristics of the object. In embodiments of the present invention, monitoring system 130 can initiate re-routing the target object so that corrections can be made to the target object to correct the discrepancy. For example, a pallet comprising fewer boxes than is described in data storage system 140 may be re-routed to correct the discrepancy. Alternatively, modification component may modify the virtually described characteristics of target object 150 that are stored in data storage system 140. For example, if the virtually described characteristic of target object 150 indicates that 100 boxes should be on a pallet, and only 98 boxes are in fact detected, monitoring system 130 may cause data storage system 140 to update the virtually described characteristic of target object 150 so that it now indicates that 98 boxes are on the pallet. Furthermore, embodiments of the present invention facilitate making routing decisions for a target object based upon the aggregation of the sensible characteristics and the virtually described characteristics of the target object.

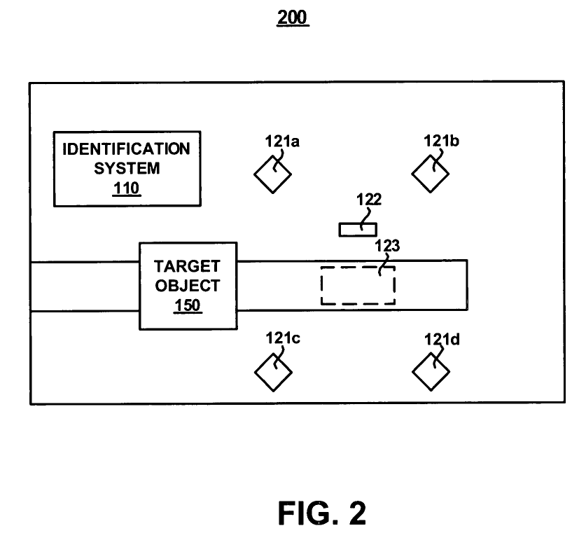

FIG. 2 is a diagram of a multi-sensor environment 200 in accordance with embodiments of the present invention. It is appreciated that environment 200 may be implemented at a variety of points in the delivery of target object 150 between two or more parties. For example, a manufacturer may implement environment 200 prior to shipping target object 150 to a recipient. Alternatively, a commercial shipping enterprise may implement environment 200 to confirm that the virtually described characteristic of target object 150 does in fact correlate with one or more sensible characteristics. In other words, the commercial shipping enterprise can verify that a pallet that is supposed to comprise 100 boxes of a product does in fact comprise 100 boxes. Embodiments of the present invention may be implemented a various nodes in a shipping network to more accurately determine where, when, and in what manner the contents of target object 150 may have been altered. Finally, an end recipient may implement environment 200 to verify that the contents of target object 150, as stated on the invoice, do in fact correspond with what has been received.

In FIG. 2, target object 150 is moved past identification system 110 via conveyor belt 210. It is appreciated that conveyor belt 210 is one of a variety of systems for transporting target object 150 and that other methods of transporting target object 150 may be used. As target object 150 is conveyed past identification system 110, its identity is established and sent to data storage system 140. As target object is conveyed into an area of environment 200 where sensible characteristics can be determined. It is appreciated that the sequence of events may be reversed, that is, that sensible characteristics of target object 150 may be determined prior to, or simultaneous with the identification of target object 150.

In environment 200, a plurality of cameras (e.g., 121a, 121b, 121c, and 121d) are disposed in a manner in which they can detect target object 150. In embodiments of the present invention, cameras 121a-121d may be operable to determine the size and/or shape of target object 150 and/or sub components thereof. For example, a reticle may be placed in the focal plane of cameras 121a-121d to facilitate determining the size of target object 150. Alternatively, cameras 121a-121d may be operative to detecting other electro-magnetic emissions from target object 150 such as emissions in infra-red spectrum. Environment 200 further comprises a temperature sensor 122 and a scale 123 which is disposed beneath conveyor belt 210. Temperature sensor 122 can be used to detect the temperature of target object 150 and/or a sub component thereof. This is useful when target object 150 comprises an object in which temperature parameters are important to the viability of the object. For example, if target object 150 comprises a pallet of ice cream containers, it is important that target object 150 is maintained at a temperature below the melting point of the ice cream otherwise it is no longer a viable product. Scale 123 may be used to determine the weight of target object 150. In embodiments of the present invention, sensible characteristics determined by more than one sensor type may be aggregated. For example, the weight of target object 150, as determined by scale 123, as well as the volume of target object 150, as determined by cameras 121a-121d, may be aggregated to determine the density of target object. This may be useful in determining, for example, whether an empty box has been loaded on a pallet, or whether target object 150 has not been loaded, leaving an empty space within. It is appreciated that embodiments of the present invention may use other sensor types than those shown in FIG. 2 depending upon the needs of the system.

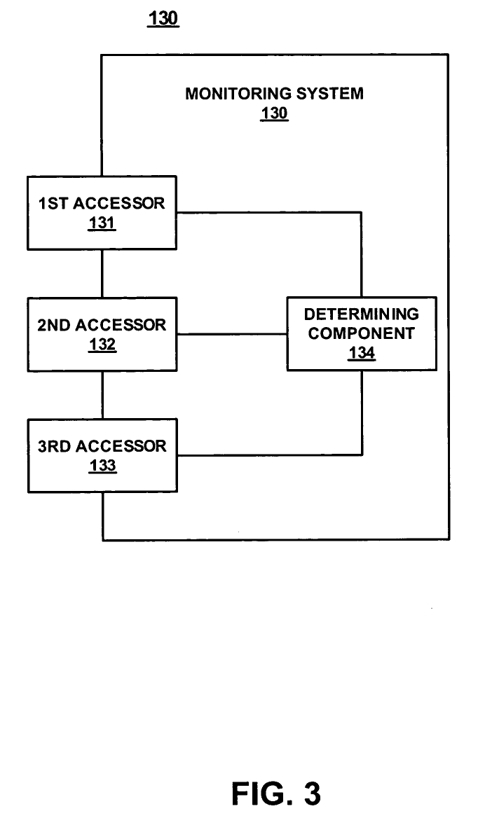

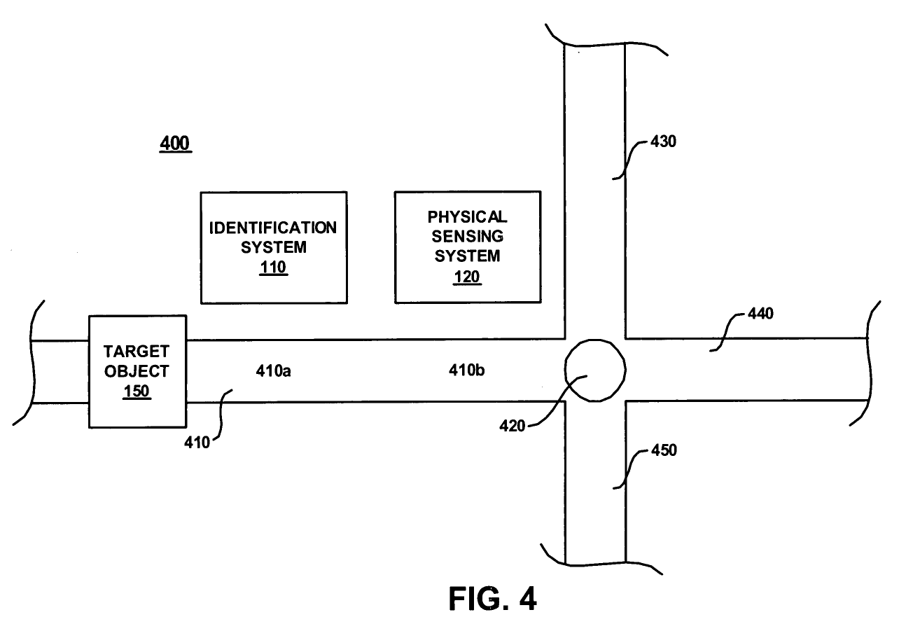

FIG. 3 is a block diagram of an exemplary monitoring system 130 in accordance with embodiments of the present invention. In FIG. 3, monitoring system 130 comprises a 1^{st} accessor 131 which may be coupled with, for example, identification system 110 via coupling 154. Monitoring system 130 further comprises a 2^{nd} accessor 132 which may be coupled with, for example, physical sensing system 120 via coupling 153. Furthermore, monitoring system 130 comprises a 3^{rd} accessor 133 which may be coupled with, for example, data storage system 140 via coupling 152. As described above with reference to FIG. 1, the configuration of monitoring system 130 may not require the specific configuration shown in FIG. 3. For example, in the configuration of FIG. 1, 3^{rd} accessor 133 may be superfluous. In the embodiment of FIG. 3, 1^{st} accessor 131, 2^{nd} accessor 132, and 3^{rd} accessor 133 are coupled with determining component 134. In embodiments of the present invention, determining component 134 is for determining whether the virtually described characteristic of target object 150 received via 3^{rd} accessor 133, corresponds with one or more sensible characteristics received via 2^{nd} accessor 132. In embodiments of the present invention, monitoring system 130 is also for initiating an event in response to comparing the virtually described characteristic of target object 150 and the sensible characteristic of target object. For example, in one embodiment, monitoring system 130 may be coupled with reporting system 160 via 3^{rd} accessor 133. In another embodiment, monitoring system 130 may be coupled with a routing device (e.g., 420 of FIG. 4) to send target object 150 to a particular destination based upon the comparing of its virtually described characteristic with its sensible characteristic.

FIG. 4 is a block diagram of another exemplary multi-sensor system 400 in accordance with embodiments of the present invention. In system 400, target object is transported via conveyor belt 410. Again, conveyor belt is an exemplary method for transporting target object 150. When target object 150 is conveyed to region 410a, its identity is determined using identification system 110. The identity of target object 150 is then conveyed to data storage system 140 and/or monitoring system 130. When target object 150 is conveyed to region 410b, at least one sensible characteristic of target object 150 is determined by physical sensing system 120. In embodiments of the present invention, the sensible characteristic of target object 150 is then conveyed to monitoring system 130. In embodiments of the present invention, based upon a comparison of a virtually described characteristic of target object 150 stored by data storage system 140 and a sensible characteristic of target object 150, monitoring system 130 may initiate routing target object 150 to a particular destination. In the embodiment of FIG. 4 a routing device 420 is operable to be communicatively coupled with monitoring system 130 and for directing target object 150 to an appropriate destination based upon a from monitoring system 130. For example, based upon the identification of target object 150 and a sensible characteristic of target object 150, routing device 420 can route target object 150 to path 430, 440, or 450.

Aggregating the identification information and the sensible characteristics of target object 150 facilitates defining specific behaviors for system 400 that are not possible if the system only had access to the stored information (e.g., the identity of target object 150) or the physical properties of target object 150. For example, if the following sequence of target objects are being transported by conveyor belt 410:

1. A box containing cartridges, volume 10 liters.

2. A box containing cartridges, volume 20 liters.

3. A box without identification, volume 20 liters.

If system 400 is equipped with identification system 110 only, the information retrieved would be the following:

1. A box containing cartridges.

2. A box containing cartridges.

3. A box without identifier.

In this scenario, boxes 1 and 2 would be subject to the same routing decision (e.g., routed to path 430) based upon the determination that both boxes contain cartridges. On the other hand, if system 400 is equipped with physical sensing system 120 only, the following information would be retrieved:

1. An object with a volume of 10 liters.

2. An object with a volume of 20 liters.

3. An object with a volume of 20 liters.

Based upon this information, boxes 2 and 3 would be subject to the same routing decision (e.g., routed to path 440). However, in embodiments of the present invention, monitoring system 130 is capable of making a more refined routing decision based upon the aggregation of the identification data and one or more sensible characteristics of the target object. Thus, in the embodiment of FIG. 4, each of the boxes may be subject to being routed separately (e.g., paths 430, 440, and 450 respectively).

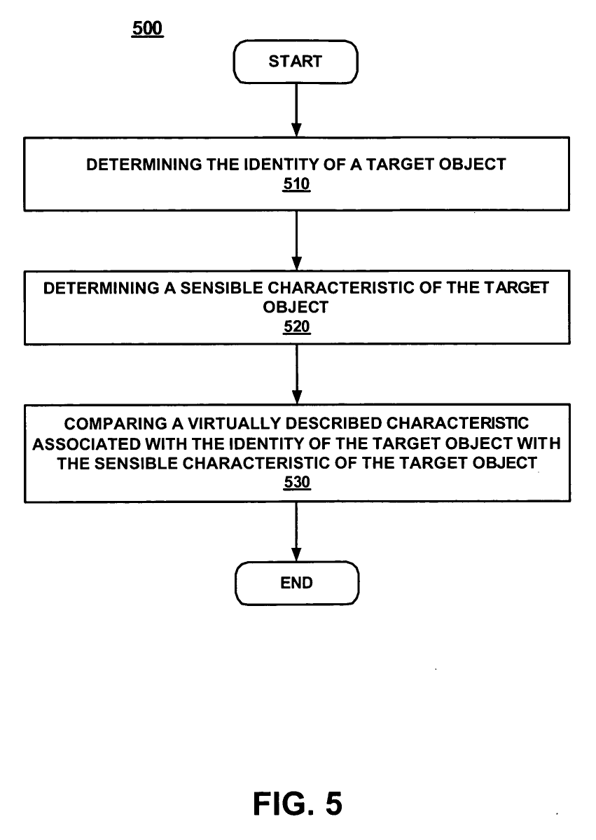

FIG. 5 is a flowchart of a method 500 for identification of a target object in accordance with embodiments of the present invention. In step 510 of FIG. 5, the identity of a target object is determined. As described above with reference to FIG. 1, identification system 110 is for identifying a target object. In embodiments of the present invention, identification of at least one sub-component of target object 150 may be performed by identification system 110. In embodiments of the present invention, the identification of target object 150 is conveyed to a data storage system (e.g., 140 of FIG. 1). This facilitates accessing at least one virtually described characteristic of target object 150.

In step 520 of FIG. 5, a sensible characteristic of the target object is determined. As described above with reference to FIG. 1, physical sensing system 120 is for detecting at least one physical characteristic of target object 150. Additionally, physical sensing system 120 can be used to determine a plurality of sensible characteristics (e.g., volume and weight) which can be aggregated by monitoring system 130 to determine a sensible characteristic (e.g., density) of target object 150.

In step 530 of FIG. 5, a virtually described characteristic associated with the identity of the target object is compared with the sensible characteristic of the target object. As described above with reference to FIG. 1, monitoring system 130 accesses the virtually described characteristic of target object 150 and compares it with sensible characteristic of target object 150 accessed via physical sensing system 120. Based upon this comparison, monitoring system 130 can initiate an action such as, for example, generating a report and/or routing target object 150 to a particular destination.

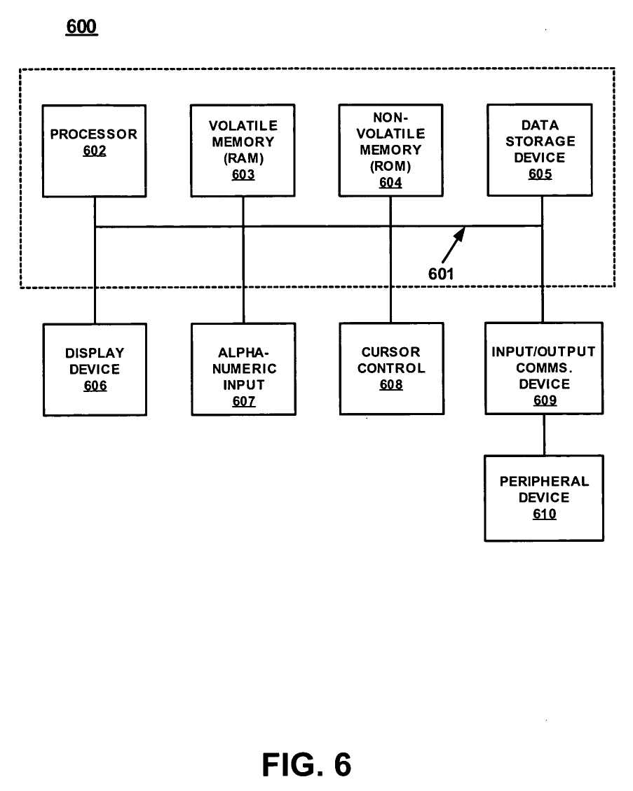

With reference to FIG. 6, portions of the present invention are comprised of computer-readable and computer-executable instructions that reside, for example, in computer system 600 which is used as a part of a general purpose computer network (not shown). It is appreciated that computer system 600 of FIG. 6 is exemplary only and that the present invention can operate within a number of different computer systems including general-purpose computer systems, embedded computer systems, laptop computer systems, hand-held computer systems, and stand-alone computer systems.

In the present embodiment, computer system 600 includes an address/data bus 601 for conveying digital information between the various components, a central processor unit (CPU) 602 for processing the digital information and instructions, a volatile main memory 603 comprised of volatile random access memory (RAM) for storing the digital information and instructions, and a non-volatile read only memory (ROM) 604 for storing information and instructions of a more permanent nature. In addition, computer system 600 may also include a data storage device 605 (e.g., a magnetic, optical, floppy, or tape drive or the like) for storing vast amounts of data. It should be noted that the software program for performing a method for identification of a target object of the present invention can be stored either in volatile memory 603, data storage device 605, or in an external storage device (not shown).

Devices which are optionally coupled to computer system 600 include a display device 606 for displaying information to a computer user, an alpha-numeric input device 607 (e.g., a keyboard), and a cursor control device 608 (e.g., mouse, trackball, light pen, etc.) for inputting data, selections, updates, etc. Computer system 600 can also include a mechanism for emitting an audible signal (not shown).

Returning still to FIG. 6, optional display device 606 of FIG. 6 may be a liquid crystal device, cathode ray tube, or other display device suitable for creating graphic images and alpha-numeric characters recognizable to a user. Optional cursor control device 608 allows the computer user to dynamically signal the two dimensional movement of a visible symbol (cursor) on a display screen of display device 606. Many implementations of cursor control device 608 are known in the art including a trackball, mouse, touch pad, joystick, or special keys on alpha-numeric input 607 capable of signaling movement of a given direction or manner displacement. Alternatively, it will be appreciated that a cursor can be directed an/or activated via input from alpha-numeric input 607 using special keys and key sequence commands. Alternatively, the cursor may be directed and/or activated via input from a number of specially adapted cursor directing devices.

Furthermore, computer system 600 can include an input/output (I/O) signal unit (e.g., interface) 609 for interfacing with a peripheral device 610 (e.g., a computer network, modem, mass storage device, etc.). Accordingly, computer system 600 may be coupled in a network, such as a client/server environment, whereby a number of clients (e.g., personal computers, workstations, portable computers, minicomputers, terminals, etc.) are used to run processes for performing desired tasks. In particular, computer system 600 can be coupled in a system for identification and data collection.

The preferred embodiment of the present invention, a multi-sensor system for identification and data collection, is thus described. While the present invention has been described in particular embodiments, it should be appreciated that the present invention should not be construed as limited by such embodiments, but rather construed according to the following claims.

What is claimed is:

1. A multi-sensor system for identification and data collection, said system comprising:
an identification system for determining the identity of a target object;
a physical sensing system for determining at least one sensible characteristic of said target object; and
a monitoring system coupled with said identification system and with said physical sensing system, said monitoring system for comparing a virtually described characteristic which is associated with said identity of said target object with said at least one sensible characteristic of said target object.

2. The multi-sensor system of claim 1 wherein said identification system is an automatic identification system.

3. The multi-sensor system of claim 1 wherein said physical sensing system is selected from the group consisting essentially of:
an optical sensing system, a weight sensing system, a shape sensing system, a pattern sensing system, a color sensing system, and a temperature sensing system.

4. The multi-sensor system of claim 1 further comprising:
a data storage system that is communicatively coupleable with said identification system and with said monitoring system and for storing said virtually described characteristic of said target object based upon the identity of said target object.

5. The multi-sensor system of claim 4 wherein said target object comprises a plurality of sub-components and wherein said monitoring system is for determining the number of said plurality of sub-components based upon said at least one sensible characteristic of said target object.

6. The multi-sensor system of claim 5 wherein said identification system is operable for detecting each of said sub-components individually.

7. The multi-sensor system of claim 5 wherein said data storage system is further for storing at least one sensible characteristic of said plurality of sub-components.

8. The multi-sensor system of claim 1 wherein said monitoring system further comprises:
a reporting system for initiating an event in response to said comparing.

9. The multi-sensor system of claim 8 wherein said reporting system is further for routing said target object in response to said comparing.

10. A monitoring system comprising:
a first input accessor for accessing an identification system, and wherein said identification system determines the identity of a target object;
a second input accessor for accessing a physical sensing system, and wherein said physical sensing system determines at least one sensible characteristic of said target object; and
a determining component for comparing a virtually described characteristic which is associated with said identity of said target object with said at least one sensible characteristic of said target object.

11. The monitoring system of claim 10 wherein said identification system is an automatic identification system.

12. The monitoring system of claim 10 wherein said physical sensing system is selected from the group consisting essentially of:
an optical sensing system, a weight sensing system, a shape sensing system, a pattern sensing system, a color sensing system, and a temperature sensing system.

13. The monitoring system of claim 10 further comprising:
a third input accessor for accessing a data storage system that is communicatively coupleable with said identification system and with said monitoring system and for storing said virtually described characteristic of said target object based upon the identity of said target object.

14. The monitoring system of claim 13 wherein said target object comprises a plurality of sub-components and wherein said monitoring system is for determining the number of said plurality of sub-components based upon said at least one sensible characteristic of said target object.

15. The monitoring system of claim 14 wherein said identification system is operable for detecting each of said sub-components individually.

16. The monitoring system of claim 14 wherein said data storage system is further for storing at least one sensible characteristic of said plurality of sub-components.

17. The monitoring system of claim 10 wherein said monitoring system further comprises:
a reporting system for initiating an event in response to said comparing.

18. The monitoring system of claim 17 wherein said reporting system is further for routing said target object in response to said comparing.

19. A method for identification of a target object, said method comprising:
determining the identity of a target object;
determining at least one sensible characteristic of said target object; and
comparing a virtually described characteristic associated with said identity of said target object with said at least one sensible characteristic of said target object.

20. The method as recited in claim 19 wherein said determining said identity of said target object comprises:
utilizing an automatic identification system to determine said identity.

21. The method as recited in claim 19 wherein said determining said at least one sensible characteristic comprises:
utilizing a physical sensing system which is selected from the group consisting essentially of:
an optical sensing system, a weight sensing system, a shape sensing system, a pattern sensing system, a color sensing system, and a temperature sensing system.

22. The method as recited in claim 19 further comprising:
storing said virtually described characteristic of said target object in a data storage system.

23. The method as recited in claim 22 wherein said target object comprises a plurality of sub-components and wherein said method further comprises:
determining the number of said plurality of sub-components based upon said at least one sensible characteristic of said target object.

24. The method as recited in claim 23 further comprising:
detecting each of said sub-components individually.

25. The method as recited in claim 23 further comprising:
storing at least one sensible characteristic of said plurality of sub-components.

26. The method as recited in claim 19 further comprising:
initiating an event in response to said comparing.

27. The method as recited in claim 26 further comprising:
routing said target object in response to said comparing.

28. A computer usable medium having computer readable program coed embodied therein for causing a computer system to perform a method for identification of a target object, said method comprising:
determining the identity of a target object;
determining at least one sensible characteristic of said target object; and
comparing a virtually described characteristic associated with said identity of said target object with said at least one sensible characteristic of said target object.

29. The computer usable medium of claim 28 wherein said determining said identity of said target object comprises:
utilizing an automatic identification system to determine said identity.

30. The computer usable medium of claim 28 wherein said determining said at least one sensible characteristic comprises:
utilizing a physical sensing system which is selected from the group consisting essentially of:
an optical sensing system, a weight sensing system, a shape sensing system, a pattern sensing system, a color sensing system, and a temperature sensing system.

31. The computer usable medium of claim 28 wherein said method further comprises:
storing said virtually described characteristic of said target object in a data storage system.

32. The computer usable medium of claim 31 wherein said target object comprises a plurality of sub-components and wherein said method further comprises:
determining the number of said plurality of sub-components based upon said at least one sensible characteristic of said target object.

33. The computer usable medium of claim 32 wherein said method further comprises:
detecting each of said sub-components individually.

34. The computer usable medium of claim 32 wherein said method further comprises:
storing at least one sensible characteristic of said plurality of sub-components.

35. The computer usable medium of claim 28 wherein said method further comprises:
initiating an event in response to said comparing.

36. The computer usable medium of claim 35 wherein said method further comprises:
routing said target object in response to said comparing.
